(19) United States
(12) Patent Application Publication
(10) Pub. No.: US 2001/0027435 A1
(43) Pub. Date: Oct. 4, 2001

(54) Electronic-money settlement method and information processing apparatus therefor

(76) Inventors: Motoshi Asano, Tokyo (JP); Makoto Yamada, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/774,682

(22) Filed: Feb. 1, 2001

(30) Foreign Application Priority Data
Feb. 2, 2000 (JP) P2000-030218

(51) Int. Cl. G06F 17/60

(52) U.S. Cl. 705/38; 705/41

(57) ABSTRACT

An electronic-money settlement method and information processing apparatus use a portable information device and a management center. when an amount of electronic money deposited in the portable information device is insufficient for a payment amount, information on a loan made to the user of the portable information device up to a predetermined limit is recorded by the portable information device and the management center.

### BACKGROUND OF THE INVENTION

1. Field of the Invention

The present invention relates to information processing systems and information processing apparatuses. In particular, the present invention can be applied to an electronic money system using portable information devices. According to the present invention, when an amount of electronic money deposited in an information processing apparatus is insufficient for a payment amount, by loaning money up to a predetermined limit to the user of the information processing apparatus and recording the amount of the loan in the information processing apparatus and a management center, the user can use electronic money even if a small amount of electronic money is deposited in the information processing apparatus.

2. Description of the Related Art

In certain areas, electronic money systems that use portable information terminals carried by users are in use. In systems of this type, by depositing electronic money beforehand from an account of each user in an integrated circuit (IC) card as a portable information terminal, each user can purchase goods, etc., at stores using the amount of electronic money deposited in the IC card.

Concerning the IC-card electronic money systems, two types have been proposed. One is a closed loop system that performs integrated management of the use of IC cards carried by users by data communication between each terminal device at each store and a predetermined management center. Another is an open loop system that does not perform this type of management.

A type of IC-card electronic money system has been designed so that shopping is allowed up to the amount of electronic money deposited in an IC card, and is considered, so to speak, a prepaid card system.

Concerning this type of IC-card electronic money system, despite an insufficient amount of electronic money being deposited in the IC card, a user who actually uses electronic money may try to use the electronic money system to make a payment due to miscalculation. In this case, a problem occurs in the conventional IC-card electronic money system using IC cards as portable information terminals in that the user cannot make a payment after all.

When a very small amount of electronic money remains in the IC card after it is used, a problem also occurs in that payment is impossible depending on the type of the IC card. In this case, the user must perform payment using a conventional means of settlement such as cash or a credit card.

It is possible to greatly enhance the convenience of using the electronic money system if the above problems are solved.

### SUMMARY OF THE INVENTION

The present invention is made in view of the foregoing problems and is intended to provide a settlement method using electronic money and an information processing apparatus used therefor in which electronic money can be used even if the amount of electronic money deposited in a portable information terminal is small.

To this end, according to an aspect of the present invention, the foregoing object is achieved through provision of an electronic-money settlement method including the steps of: recording, in a portable electronic device and a management center, information on a deposited amount of money, the information being stored in the portable electronic device in the form of electronic money representing a monetary value; and recording, in the portable electronic device and the management center, information on a loan made to the user of the portable electronic device up to a predetermined limit when a payment amount exceeds the remaining amount of the electronic money stored in the portable electronic device.

Preferably, the management center calculates interest on the loan at a predetermined frequency, and uses the calculation result to update the information on the loan.

When the loan exceeds a predetermined limit, the management center may prohibit the use of electronic money by the portable electronic device.

The management center may update a record of the remaining amount of the electronic money stored in the portable electronic device when being instructed to store electronic money in the portable electronic device, and may update the remaining amount of the electronic money stored in the portable electronic device when being accessed by the portable electronic device so that priority is given to liquidation of the loan.

According to another aspect of the present invention, the foregoing object is achieved through provision of an information processing apparatus that subtracts a used amount from a monetary value stored in a portable electronic device in the form of electronic money so that the remaining amount of the electronic money in the portable electronic device is updated. The information processing apparatus includes a first unit for notifying a management center of the updated amount, and a second unit in which, when a payment amount exceeds the remaining amount of the electronic money stored in the portable electronic device, the second unit records information on a loan made to the user of the portable electronic device in the portable electronic device, and notifies the management center of the information.

Preferably, the information processing apparatus further includes a third unit for prohibiting the use of the electronic money by the portable electronic device when being notified that the loan exceeds a predetermined limit.

As described above, according to the present invention, when an amount of electronic money deposited in a portable information device is insufficient for a payment amount, by recording in the portable information device and a management center information on a loan made to the user of the portable information device up to a limited amount, electronic money can be used even if the amount of electronic money deposited in the portable information device is small.

### BRIEF DESCRIPTION OF THE DRAWINGS

FIG. 1 is a flowchart showing a process by a host computer in a management center in an electronic money system 1 according to an embodiment of the present invention;

FIG. 2 is a block diagram showing the entire structure of an electronic money system 1 according to an embodiment of the present invention;

FIG. 3 is a schematic drawing illustrating the process in FIG. 1;

FIG. 4 is a schematic drawing showing loan using electronic money;

FIG. 5 is a flowchart showing a process for managing a loan;

FIG. 6 is a schematic drawing illustrating a case in which a loan exceeds a limited amount;

FIG. 7 is a schematic drawing illustrating depositing in a case in which a loan exceeds a limited amount;

FIG. 8 is a flowchart showing a process on an IC card as a remitter; and

FIG. 9 is a flowchart showing a process on an IC card as a remittee.

### DESCRIPTION OF THE PREFERRED EMBODIMENTS

An embodiment of the present invention is described below with reference to the drawings.

1. Construction of Embodiment

1-1. Entire Structure of Electronic Money System

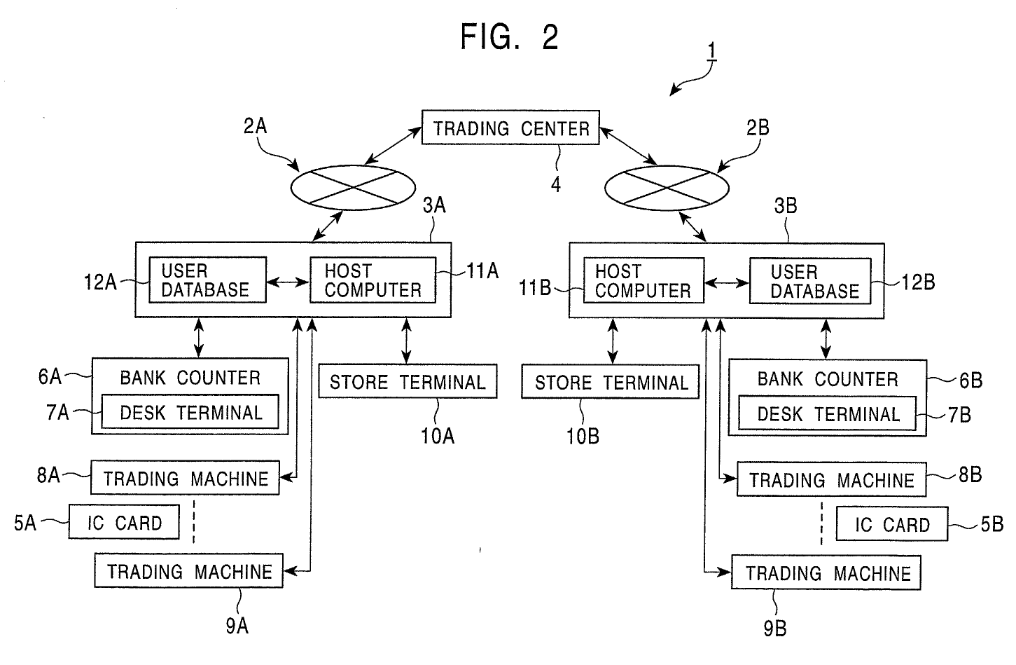

FIG. 2 is a block diagram showing an electronic money system 1 according to an embodiment of the present invention. In the electronic money system 1, two management centers 3A and 3B corresponding to two types of IC card systems 2A and 2B are linked by a trading center 4, whereby electronic money corresponding to the IC card system 2A, and electronic money corresponding to the IC card system 2B can be used at stores belonging to the IC card systems 2A and 2B.

In the electronic money system 1, the IC card systems 2A and 2B are identical in structure, as separately shown in FIG. 2 by using combinations of identical numbers and alphabets A and B to denote corresponding components. Accordingly, the IC card system 2A is mainly described, omitting repetition of the same description. Although components that constitute the electronic money system 1 communicate with one another by performing data communication using encryption with a public key or the like, a description of processing for the encryption is omitted below for brevity of description.

In the electronic money system 1, the trading center 4 includes the management centers 3A and 3B for the IC card systems 2A and 2B, and host computers 11A and 11B linked by a predetermined network. The trading center 4 relays transmission and reception of data between the management centers 3A and 3B, and further performs processes such as offsetting for transfer of fund between the management centers 3A and 3B.

The IC card system 2A is a closed-loop electronic money system 1 managed by the management center 3A, and uses the management center 3A to manage an IC card 5A issued by the management center 3A.

In this embodiment, the IC card 5A is, for example, a non-contact memory card, and is designed to record and hold in a built-in memory data such as an amount of electronic money and a history of use. When being accessed by a desk terminal 7A at a bank counter 6A, trading machine 8A or 9A, or a store terminal 10A, the IC card 5A transfers and updates the data recorded in the built-in memory. This enables the depositing of electronic money from the desk terminal 7A or the trading terminal 8A or 9A in the IC card 5A, and the deposited electronic money is usable at stores.

Specifically, the desk terminal 7A at the bank counter 6A intermittently transmits a call to the IC card 5A at a predetermined frequency. When being held close to the desk terminal 7A, the IC card 5A starts to operate by power induced in its antenna, and transmits a response to the call. When receiving the response from the IC card 5A, the desk terminal 7A performs processing for mutual authentication with the IC card 5A. When obtaining verification by the authentication, the desk terminal 7A reads an identification code assigned to the IC card 5A and the amount of electronic money deposited in the IC card 5A from the IC card 5A. The desk terminal 7A notifies the management center 3A of the read identification code and amount with the user's password. Also, by performing data communication with the management center 3A in accordance with operations by an operator, the desk terminal 7A deposits electronic money in the IC card 5A and adjusts the electronic money recorded in the IC card 5A. During these processes, the desk terminal 7A uses a predetermined display portion to display the remaining amount (balance) of electronic money deposited in the IC card 5A, an amount of electronic money spent in the past, a history of use in connection with charges required for a series of processes, interest, etc.

When the desk terminal 7A is provided at the bank counter 6A, it is designed to perform general banking processing in addition to the processes for the IC card 5A.

The trading machines 8A and 9A are terminal units similar to automated teller machines for banks, and are provided in, for example, banks, stores, etc., with the automated teller machines. Similarly to the desk terminal 7A at the bank counter 6A, the trading machine 8A or 9A performs processing for mutual authentication with the IC card 5A, and notifies the management center 3A of the identification code of the IC card 5A, the amount of electronic money in the IC card 5A, and the password for the IC card 5A. Also, by performing data communication with the management center 3A in accordance with operations by the user, electronic money is deposited in the IC card 5A and the electronic money recorded in the IC card 5A is adjusted. During these processes, the trading machines 8A and 9A each use a predetermined display portion to display the balance of electronic money deposited in the IC card 5A, the amount of electronic money spent in the past, a history of use in connection with charges required for a series of processes, interest, etc.

The store terminal 10A is provided in each store or the like where the electronic money of the IC card 5A is used. Similarly to the desk terminal 7A at the bank counter 6A, the store terminal 10A performs processing for mutual authentication with the IC card 5A, and subsequently performs processing for payment using the electronic money recorded in the IC card 5A. The store terminal 10A can display the balance of electronic money in the IC card 5A, a history of use, etc., as required, similarly to the trading machines 8A and 8B. For this processing, the store terminal 10A records the use of the IC card 5A, notifies the management center 3A of the record at a predetermined frequency, and obtains a negative list from the management center 3A.

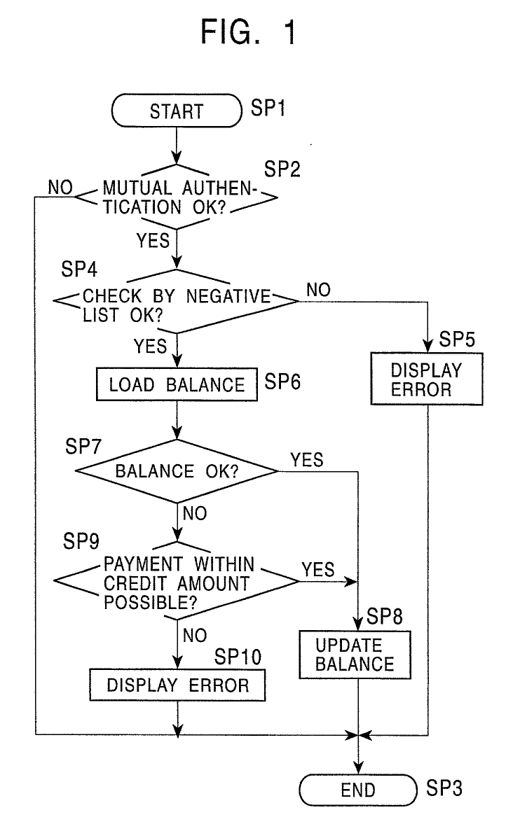

As shown in FIG. 1, when receiving a response from the IC card 5A, the store terminal 10A starts to operate in step SP1, and performs processing for mutual authentication with the IC card 5A in step SP2. If it is found in step SP2 that the IC card 5A is not adapted for systems other than the IC card systems 2A and 2B, the store terminal 10A proceeds from step SP2 to step SP3 since the mutual authentication is impossible, and terminates its processing.

Conversely, if the store terminal 10A has determined as a result of the mutual authentication that the IC card 5A is adapted for the IC card system 2A or 2B, the store terminal 10A proceeds from step SP2 to step SP4. In step SP4, the store terminal 10A reads the identification code from the IC card 5A, and retrieves a negative list posted from the management center 3A based on the identification code. The store terminal 10A uses the negative list to determine whether the IC card 5A is disabled based on the negative list. The negative list is a list of identification codes that are periodically posted from the management center 3A. On the negative list, the identification codes of IC cards disabled on predetermined conditions are recorded.

If it is found in step SP4 that the IC card 5A corresponds to one of the IC cards recorded on the negative list, the store terminal 10A proceeds from step SP4 to step SP5, and displays an error message indicating that the IC card 5A cannot make a payment. After that, the store terminal 10A proceeds to step SP3, and terminates its processing. This enables the store terminal 10A to prevent the use of an illegal IC card and the use of an IC card based on credit over a limited amount.

If the IC card 5A is not listed on the negative list, the store terminal 10A proceeds from step SP4 to step SP6. In step SP6, the balance of electronic money is loaded from the IC card 5A into the store terminal 10A. In step SP7, the store terminal 10A determines whether the loaded balance is sufficient for a payment amount. If the determination is affirmative, the store terminal 10A proceeds to step SP8. In step SP8, the store terminal 10A subtracts the amount of money required for the user to purchase goods from the balance of electronic money, and uses the obtained amount to update the balance of electronic money recorded in the IC card 5A. After that, the store terminal 10A proceeds to step SP3 and terminates its processing.

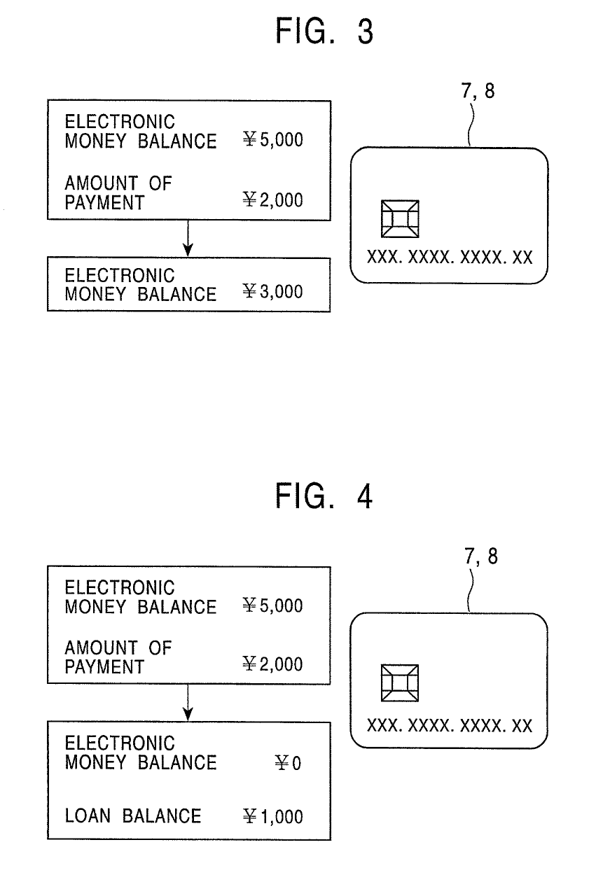

Accordingly, as shown in FIG. 3, when the balance of electronic money in the IC card 5A is sufficient, the store terminal 10A updates the balance of electronic money in the IC card 5A by subtracting the amount of payment to the store from the balance of electronic money in the IC card 5A, and performs payment processing using the IC card 5A.

If it is impossible for the user to make a payment using the balance of electronic money in the IC card 5A, the store terminal 10A proceeds from step SP7 to step SP9. In step SP9, the store terminal 10A determines whether the user can make a payment with an amount of money that is the sum of the balance in the IC card 5A and the amount of a credit. The amount of the credit is a limited amount of money that can be loaned from banking facilities under contract on the issuance of the IC card 5A when the user requests payment exceeding the balance in the IC card 5A.

If the determination is affirmative in step SP9, the store terminal 10A proceeds to step SP8, and updates the amount of electronic money recorded in the IC card 5A by using the result of subtracting the amount of purchase money from the balance. In this case, after recording the loan made to the user on credit in the IC card 5A, the store terminal 10A proceeds to step SP3, and terminates its processing.

This allows the store terminal 10A to loan electronic money up to a predetermined limit to the user so as to process user's payment when the balance in the IC card 5A is insufficient, as shown in FIG. 4.

As described above, the store terminal 10A records electronic money payment and loan using the IC card 5A, notifies the host computer 11A in the management center 3A of the record, and obtains the negative list required for these processes from the host computer 11A.

The management center 3A is the body of issuing and managing the IC card 5A, and uses the host computer 11A to perform predetermined processing in accordance with processing by the desk terminal 7A, the trading machines 8A and 9A, and the store terminal 10A by performing data communication with the desk terminal 7A, the trading machines 8A and 9A, and the store terminal 10A, whereby the depositing of electronic money in the IC card 5A used by the user is performed and payment processing is performed at a store where the IC card 5A is used. At this time, based on the record in the user database 12A, the management center 3A manages the amount deposited in the IC card 5A and logs a history of use of the IC card 5A.

When being notified of the history of use of the IC card 5A by the store terminal 10A, the host computer 11A uses the history to update the record in the user database 12A. The host computer 11A periodically performs the depositing of electronic money in the account of each store so as to establish correspondence with the history, whereby electronic money used at each store is cashed.

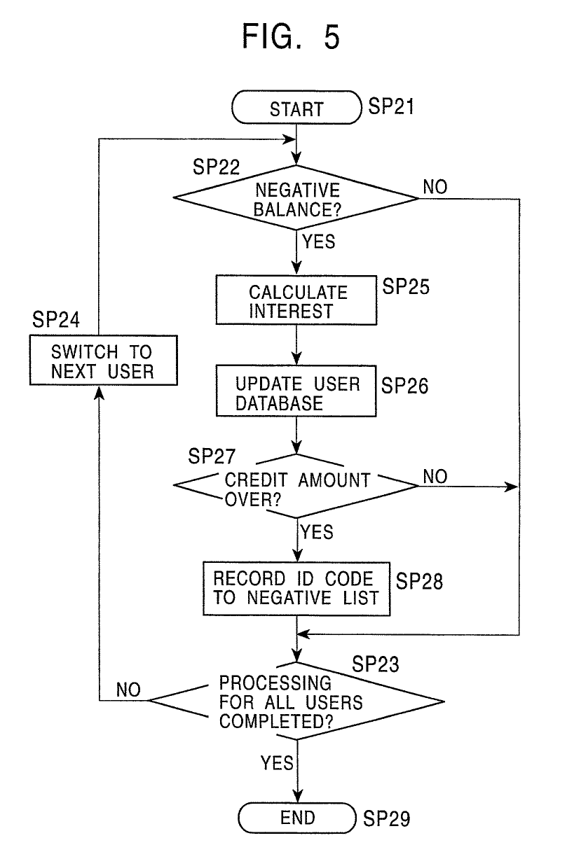

The host computer 11A also performs the process shown in FIG. 5 at, for example, a frequency of once a day, thereby calculating interest on a loan made to each user, and recording an IC card used by a predetermined user on the negative list, as required.

The host computer 11A proceeds from step SP21 to step SP22, and determines whether the balance in the IC card of the predetermined user recorded in the user database 12A is negative as a result of performing the loan. If the determination is negative in step SP22, the host computer 11A proceeds to step SP23 and determines whether the process has been completed for all the users recorded in the user database 12A. If the determination is negative in step SP23, the host computer 11A proceeds to step SP24.

After the host computer 11A switches the process subject to the next user, it proceeds back to step SP22. The host computer 11A determines whether all IC cards under management, which are recorded in the user database 12A, each have a loan.

Conversely, if the determination is affirmative in step SP22, the host computer 11A proceeds to step SP25. In step SP25, the host computer 11A calculates, for example, daily interest, and uses the calculated interest to update the information in the user database 12A in step SP26. The host computer 11A determines whether the limited amount of a credit is exceeded by the calculated interest. If the determination is negative, the host computer 11A proceeds to step SP23.

Conversely, if the limited amount of the credit is exceeded by the calculated interest, the host computer 11A proceeds from step SP27 to step SP28. After, in step SP28, the host computer 11A records, on the negative list, the identification code of the IC card in which the limited amount is exceeded, the host computer 11A proceeds to step SP22. In step SP22, as shown in FIG. 6, the host computer 11A processes user's payment by loaning electronic money up to a predetermined limit to the user of the IC card 5A. When interest on the loan causes the amount of the loan to exceed the limited amount, the host computer 11A disables the IC card 5A. Accordingly, when the host computer 11A completes these steps for all the users registered in the user database 12A, the determination is affirmative in step SP23, whereby the host computer 11A proceeds from step SP23 to step SP29 and terminates the process.

When electronic money is deposited in the IC card 5A by processing at the bank counter 6A, which is described later, and the processing by the trading machines 8A and 9A, the host computer 11A updates the information in the user database 12A. When the deposited money repays the loan and clears a loan exceeding the loan limit, the host computer 11A deletes the record on the negative list. The host computer 11A periodically notifies the store terminal 10A of the negative list made as described. Therefore, in the case shown in FIG. 6, when a minimum of 101 yen is deposited, IC-card payment can be performed.

Specifically, when the desk terminal 7A at the bank counter 6A or the trading machine 8A or 9A obtains mutual authentication with the IC card 5A, and the desk terminal 7A, etc., reads an identification code, an amount of electronic money, and a password from the IC card 5A and posts them to the host computer 11A in the management center 3A, the host computer 11A checks the read identification code and amount of electronic money using the user database 12A. If an error is here detected in the check result, cases are considered in which the amount of electronic money deposited in the IC card 5A is illegally changed and in which an IC card 5A of the third party is illegally used. Accordingly, the host computer 11A updates the record in the user database 12A, records the updated result in the negative list so that the IC card 5A is disabled, and notifies the desk terminal 7A, etc., of the fact.

Conversely, if the check result representing correspondence is obtained, the host computer 11A instructs the desk terminal 7A or the like to receive the next input. When the desk terminal 7A or the like is instructed by this notification to deposit electronic money in the IC card 5A, the host computer 11A instructs the desk terminal 7A or the like to input information on an account of a depositor, similarly to processing for fund transfer in ordinary banking. The information includes the depositor account and the amount of deposit money.

When the information on the depositor account is input, the host computer 11A verifies and posts the depositor account, the balance of money in the account, etc., to the desk terminal 7A or the like. When the host computer 11A obtains verification of the money-depositing request from the desk terminal 7A in response to the notification, the deposit money is charged from the corresponding account and the desk terminal 7A or the like is instructed to deposit the electronic money in the IC card 5A. This enables the electronic money system 1 to deposit electronic money from the account of each person to the IC card 5A, as required.

At the same time, the host computer 11A updates the record in the user database 12A, thereby establishing the correspondence between the amount of electronic money recorded in the IC card 5A and the record in the user database 12A.

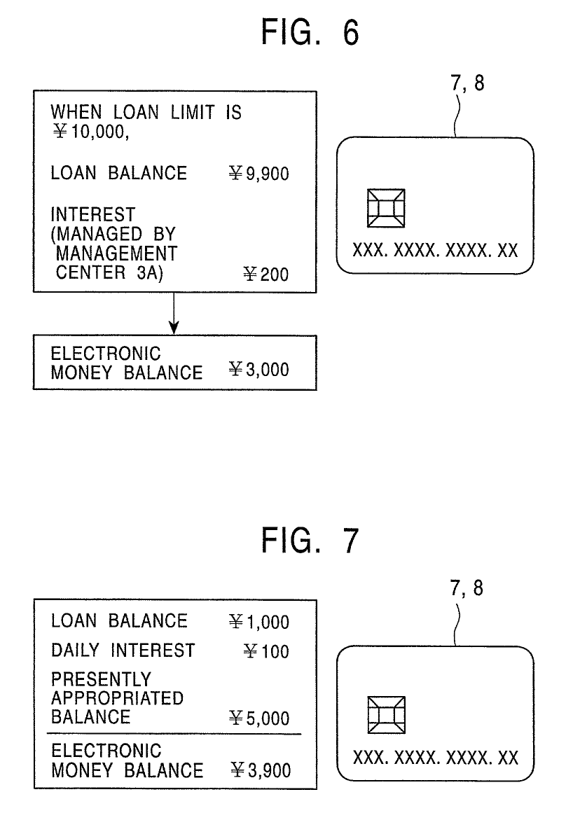

If the host computer 11A finds out, in these processes, a loan to a user by accessing the user database 12A and the record in the IC card 5A, the host computer 11A gives priority to repaying the loan by the user-deposited electronic money. Accordingly, as shown in FIG. 7, for example, in the case that 1,000 yen is loaned and interest is 100 yen, and electronic money of 5,000 yen is deposited, in order that the electronic money balance may be 3,900 yen, the record in the IC card 5A is updated and the record in the user database 12A is also updated.

When money-depositing processing is performed using the IC card 5B adapted for the IC card system 2B from the desk terminal 7A at the bank counter 6A or the like, which is managed by the host computer 11A, the host computer 11A transmits, to the host computer 11B, information from the trading machine 8A or 9A or the desk terminal 7A or the like via the trading center 4, and instructs updating on the IC card 5B under management and instructions by the host computer 11B, whereby electronic money is deposited in the IC card 5B adapted for the other system 2B. Similarly, when the history of use of the IC card 5B adapted for the IC card system 2B is posted from the store terminal 10A, the trading center 4 is used to notify the management center 3B for managing the IC card system 2B, whereby settlement can be performed by the management center 3B, to which the IC card 5B corresponds. Also, in response to a request from the management center 3B, the host computer 11A performs paying to the account of a related store, and notifies the store terminal 10A of the negative list posted from the management center 3B.

1-2. Fund Transfer between IC Cards

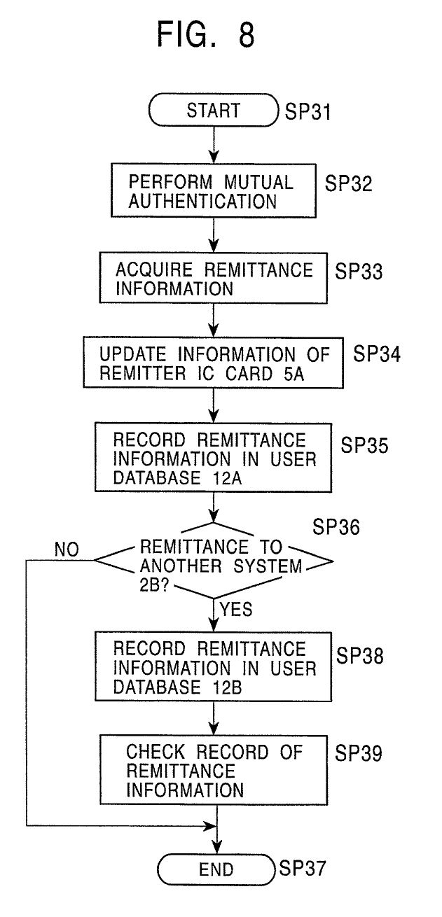

When the desk terminal 7A at the bank counter 6A, or the trading machine 8A or 9A is instructed to perform fund transfer from the IC card 5A (hereinafter referred to as the “remitter IC card”) to another IC card (hereinafter referred to as a “remittee IC card”), the host computer 11A performs the process shown in FIG. 8. Specifically, the host computer 11A proceeds from step SP31 to step SP32. When authentication processing is similarly completed as described above by the desk terminal 7A, and the trading machines 8A and 9A, the host computer 11A proceeds to step SP33, and acquires remittance information including the identification code of the remittee IC card, the owner of the remittee IC card, and a remittance amount.

When acquiring the remittance information, the host computer 11A instructs the desk terminal 7A or the trading machine 8A or 9A in step SP34 to reduce the amount of electronic money recorded in the remitter IC card 5A by the remittance amount.

Subsequently proceeding to step SP35, the host computer 11A records the remittance information in the user database 12A. When recording the remittance information, the host computer 11A records, in the user database 12A, the electronic money in the remitter IC card 5A from which the remittance amount is subtracted, together with the history.

Proceeding to step SP36, the host computer 11A determines whether the remittee IC card belongs to another IC card system. If the determination is negative in step SP36, the host computer 11A proceeds from step SP36 to step SP37, and terminates the process.

Conversely, if the remitter IC card belongs to the other IC card system 2B, the host computer 11A proceeds to step SP38 since the determination is negative in step SP36. Here, the host computer 11A transmits the remittance information to the management center 3B as a remittee, and the host computer 11B in the management center 3B performs processing so that the remittance information is recorded in the user database 12B. In step SP39, the host computer 11A proceeds to step SP37 and terminates the process when being notified of the recording of the remittance information by the remittee management center 3B.

In these steps, the host computer 11A can temporarily record and hold the remittance information from the IC card 5A. By recording the remittance information, as described above, when a remittance is made to, for example, a remote place, remittance of electronic money is posted by communication such as telephone from a user as a remitter to a user as a remittee, and this notification allows the user that owns the remittee IC card to come to the trading machine 8A or 9B in the IC card system 2A or 2B, or the bank counter 6A or 6B. Also, when electronic money is exchanged between friends who accompany the card owner, the remittee IC card instantly performs money-depositing processing at the bank counter 6A or the trading machine 8A or 9A, to which a remittance destination is input.

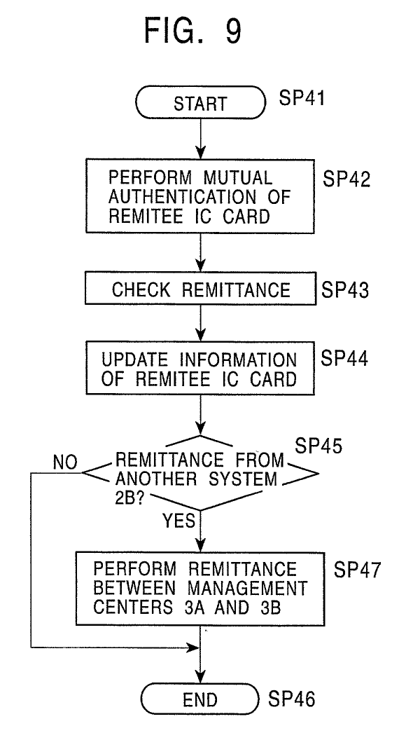

FIG. 9 is a flowchart showing a process by the host computer 11A for the depositing processing. The host computer 11A proceeds from step SP41 to step SP42, and when it here completes authentication processing on the remittee IC card by the desk terminal 7A or the trading machine 8A or 9A, it performs remittance confirming processing in step SP43. In step SP43, the host computer 11A confirms whether the IC card is a remittee by comparing the remittance information recorded in the user database 12A and the identification code of the IC card, checking the password input by the trading machine 8A or 9A, or the desk terminal 7A, etc.

The host computer 11A instructs the trading machine 8A or 9A or the desk terminal 7A to increase the electronic money recorded in the remittee IC card by the remittance amount, updates the record in the user database 12A so that the record corresponds to the amount of electronic money in the IC card which is updated by the instruction, and sets the remittance information recorded in the user database 12A so that it represents completion of remittance.

Proceeding to step SP45, the host computer 11A determines whether the remitter is an IC card belonging to the other IC card system 2B, and if the determination is negative, the host computer 11A proceeds to step SP46 and terminates the process. Conversely, if the remitter is an IC card belonging to the other IC card system 2B, the host computer 11A proceeds to step SP47, and notifies the corresponding management center 3B of completion of transmittance to the IC card, whereby the remittance information recorded in the management center 3B is set so as to represent completion of remittance. After executing settlement processing in accordance with the above transfer of electronic money in cooperation with the management center 3B, the host computer 11A proceeds to step SP46 and terminates the process.

2. Operation of Embodiment

In the above-described construction, in the electronic money system (FIG. 2), by operating the desk terminal 7A at the bank counter 6A, or the trading machine 8A or 9A, electronic money is deposited in the IC card 5A carried by the user. When the user purchases an item at a store and selects payment by electronic money, the electronic money recorded in the IC card 5A is reduced by the payment amount.

In these processes, in the IC card 5A carried by the user, when electronic money is deposited, the recorded amount of electronic money is updated corresponding to the deposit amount, and the recorded amount of electronic money is reduced corresponding to the payment amount. In parallel to these processes, when electronic money is deposited, the amount of electronic money recorded in the user database 12A is updated by online communication between the desk terminal 7A or the trading machine 8A or 9A and the management center 3A. Also, when payment is made, the store terminal 10A periodically accesses the management center 3A, whereby the management center 3A is notified of the use of the IC card 5A. This notification updates the amount of electronic money recorded in the user database 12A. In accordance with the use of electronic money, processing for depositing to the account of the store is performed.

Accordingly, in the electronic money system 1, under management by the management center 3A, settlement processing is performed in accordance with the electronic money recorded in the IC card 5A as a portable information device. By recording the amount of electronic money deposited in the IC card 5A in the IC card 5A and the management center 3A, an electronic money system based on the so-called “closed loop system” is constructed.

Since payment processing with electronic money is performed as described above, when the amount of electronic money deposited in the IC card 5A is small and insufficient for a payment amount, the electronic money system 1 performs processing for loaning only an insufficient amount to the user who carries the IC card 5A within a credit amount. In addition, the amount of electronic money deposited in the IC card 5A is updated to be zero yen, and the loan amount is recorded in the IC card 5A (FIGS. 3 and 4). The loan is recorded by the store terminal 10, and the management center 3A is notified of the loan when being accessed. In the electronic money system 1, the information in the user database 12A is updated so as to match the record in the IC card 5A, and when the amount of electronic money deposited in the IC card 5A is insufficient for a payment amount, information on the loan made to the user of the IC card 5A up to a predetermined limit is recorded by the IC card 5A and the management center 3A.

Accordingly, since, in the electronic money system 1, the loan can be managed by the management center 3A, processing for the loan to the user of the IC card 5A within the predetermined limit can be performed when the amount of electronic money is insufficient for a payment amount. Therefore, the loan enables the use of electronic money even if the amount of electronic money deposited in the IC card 5A is small, and this can enhance user's convenience.

Concerning the loan performed as described above, the management center 3A calculates interest, for example, every day, and the interest is used to update the record in the user database 12A. This allows the electronic money system 1 to calculate interest on a loan in a predetermined frequency, and the calculated result is used to update information on the loan.

When the updating causes the loan to exceed the limit, the identification code of the IC card 5A is recorded on the negative list, and is posted to the store terminal 10A. Accordingly, in the electronic money system 1, when the loan exceeds a predetermined limit, the management center notifies the store terminal 10A of the fact so that the use of electronic money by the corresponding portable information device is prohibited. This prevents the electronic money system 1 from treating a dangerous loan exceeding the limit.

When there is the loan, and the user deposits electronic money in the IC card 5A, the electronic money system 1 updates the amount of electronic money recorded in the IC card 5A and the record in the user database 12A. At this time, in the electronic money system 1, the records in the IC card 5A and the user database 12A are updated (FIGS. 6 and 7) so that priority is given to the repaying of the loan, whereby various proceedings for the loan can be completed without complicated proceedings.

For repaying the loan, etc., when the electronic money in the IC card 5A of a person is transferred to the IC card of another person, in the desk terminal 7A or the trading machine 8A or 9A in the electronic money system 1, remittance information including a remittee IC card and a remittance amount is input after the remitter IC card 5A is authenticated.

In the electronic money system 1, in the management center 3A that manages the remitter IC card 5A, the remittance information is recorded. Also, the electronic money recorded in the remitter IC card 5A is reduced by the remittance amount of the remittance information, and the information in the user database 12A is updated corresponding to the reduction.

When the remittee IC card belongs to the same IC card system 2A to which the remitter IC card 5A belongs, the amount of electronic money recorded in the remittee IC card is increased by the remittance amount by accessing the remittee IC card by the desk terminal 7A or the trading machine 8A or 9A. The record in the user database 12A is updated so that the remittance information in the record represents completion of remittance. This enables one IC card system 2A to transfer electronic money between IC cards.

Conversely, when the remittee IC card 5B belongs to the IC card system 2B, which differs from that to which the remitter IC card 5A belong, the remittance information is also recorded in the user database of the remittee management center 3B by notification from the remitter management center 3A to the remittee management center 3B.

The remitter management center 3A instructs the remittee management center 3B to increase the electronic money recorded in the remittee IC card 5B by the remittance amount and to update the record in the remittee IC card 5B so that it corresponds to the increase.

On the remittee side, the amount of electronic money recorded in the remittee IC card is increased by the remittance amount by accessing the remittee IC card by the desk terminal 7A, 7B, or each of the trading machines 8A to 9B, and the record in the user database 12B is updated corresponding to the increase so that the remittance information represents completion of remittance. The remittance information is also recorded in the remitter user database 12B by notification from the remitter side so as to represent completion of remittance.

Accordingly, in different IC card systems, electronic money can be transferred between IC cards.

3. Effects of Embodiment

According to the foregoing embodiment, when the amount of electronic money deposited in the IC card 5A is recorded in the IC card 5A as a portable information device and the management center 3A, if the amount of electronic money deposited in the IC card 5A is insufficient for a payment amount, by recording a loan made to the user of the IC card 5A up to a predetermined limit in the IC card 5A and the management center 3A, the loan to the user can be managed, and the loan system can be operated. This enables the use of electronic money even if the amount of electronic money deposited in the portable information device is small.

At this time, the management center 3A calculates interest on the loan at a predetermined frequency and updates information on the loan using the calculation result, and also prohibits the use of electronic money with the IC card 5A when the loan exceeds a predetermined limit, whereby, in the loan of electronic money, its loan system can be operated similarly to a conventional loan system using cash, etc., and dangerous loan exceeding the limit can be prevented.

4. Other Embodiments

Although the foregoing embodiment describes a case in which electronic money is deposited in an IC card by a bank counter and a trading machine, the present invention is not limited to this case but electronic money can be deposited by a store terminal.

Although the foregoing embodiment describes a case in which information on payment of electronic money and a negative list are exchanged by periodically linking a store terminal and a management center, the present invention is not limited to this case but such information may be exchanged in real time by using online linking.

Although the foregoing embodiment describes a case in which electronic money is deposited by a desk terminal and a trading machine, the present invention is not limited to the case but may be widely applied to cases in which electronic money is deposited by a personal computer in each home.

Although the foregoing embodiment describes a case in which noncontact IC cards are used to form an electronic money system, the present invention is not limited to the case but may be widely applied to cases in which contact IC cards are used to form an electronic money system and in which an electronic money system is formed using, for example, portable information devices such as mobile phones.

What is claimed is:

1. An electronic-money settlement method comprising the steps of:
recording, in a portable electronic device and a management center, information on a deposited amount of money, said information being stored in said portable electronic device in the form of electronic money representing a monetary value; and
recording, in said portable electronic device and said management center, information on a loan made to the user of said portable electronic device up to a predetermined limit when a payment amount exceeds the remaining amount of the electronic money stored in said portable electronic device.

2. An electronic-money settlement method according to claim 1, wherein said management center calculates interest on the loan at a predetermined frequency, and uses the calculation result to update said information on the loan.

3. An electronic-money settlement method according to claim 1, wherein, when the loan exceeds a predetermined limit, said management center prohibits the use of electronic money by said portable electronic device.

4. An electronic-money settlement method according to claim 1, wherein said management center updates a record of the remaining amount of the electronic money stored in said portable electronic device when being instructed to store electronic money in said portable electronic device, and updates the remaining amount of the electronic money stored in said portable electronic device when being accessed by said portable electronic device so that priority is given to liquidation of the loan.

5. An information processing apparatus that subtracts a used amount from a monetary value stored in a portable electronic device in the form of electronic money so that the remaining amount of the electronic money in the portable electronic device is updated, said information processing apparatus comprising:
first means for notifying a management center of the updated amount; and
second means in which, when a payment amount exceeds the remaining amount of the electronic money stored in said portable electronic device, said second means records information on a loan made to the user of said portable electronic device in said portable electronic device, and notifies said management center of said information.

6. An information processing apparatus according to claim 5, further comprising third means for prohibiting the use of the electronic money by said portable electronic device when being notified that said loan exceeds a predetermined limit.
